(19) United States
(12) Patent Application Publication
(10) Pub. No.: US 2024/0369712 A1
(43) Pub. Date: Nov. 7, 2024

(54) ABNORMALITY DETERMINATION DEVICE, ABNORMALITY DETERMINATION METHOD, AND NON-TRANSITORY COMPUTER-READABLE STORAGE MEDIUM STORING ABNORMALITY DETERMINATION PROGRAM

(71) Applicant: DENSO CORPORATION, Kariya-city (JP)

(72) Inventors: SHUNICHI AKAMATSU, Kariya-city (JP); TOMOYUKI OISHI, Kariya-city (JP)

(21) Appl. No.: 18/678,852

(22) Filed: May 30, 2024

Related U.S. Application Data
(63) Continuation of application No. PCT/JP2022/041384, filed on Nov. 7, 2022.

(30) Foreign Application Priority Data
Dec. 2, 2021 (JP) 2021-196331
Oct. 7, 2022 (JP) 2022-162553

(51) Int. Cl. G01S 17/931; G01S 7/497

(52) U.S. Cl. CPC G01S 17/931; G01S 7/497

(57) ABSTRACT

By an abnormality determination device, an abnormality determination method, and a non-transitory computer-readable storage medium storing an abnormality determination program, a reflection light image and a background light image are acquired, presence or absence of a reflection light intensity change and presence or absence of a background light intensity change are identified, and an abnormality type of the LiDAR device is determined using a combination of the presence or the absence of the reflection light intensity change and the presence or the absence of the background light intensity change.

### CROSS REFERENCE TO RELATED APPLICATIONS

The present application is a continuation application of International Patent Application No. PCT/JP2022/041384 filed on Nov. 7, 2022, which designated the U.S. and claims the benefit of priority from Japanese Patent Application No. 2021-196331 filed on Dec. 2, 2021 and the benefit of priority from Japanese Patent Application No. 2022-162553 filed on Oct. 7, 2022. The entire disclosures of all of the above applications are incorporated herein by reference.

### TECHNICAL FIELD

The present disclosure relates to an abnormality determination device, an abnormality determination method, and a non-transitory computer-readable storage medium storing an abnormality determination program that detect an abnormality in a distance measurement device.

### BACKGROUND

In a comparative example, a LiDAR device is a distance measurement device that detects an object by using laser light. In a technology of the comparative example, an abnormality regarding at least one of a light receiver or a light emitter of the LiDAR device is determined according to a difference between a characteristics of an incident light intensity in a light reception target area and a characteristics of the incident light intensity in a non-light reception target area. The comparative example lists abnormalities in a light emission element, a light reception element array, a cover glass, and a scanning mechanism as abnormalities related to at least one of the light receiver or the light emitter of the LiDAR device.

### SUMMARY

By an abnormality determination device, an abnormality determination method, and a non-transitory computer-readable storage medium storing an abnormality determination program, a reflection light image and a background light image are acquired, presence or absence of a reflection light intensity change and presence or absence of a background light intensity change are identified, and an abnormality type of the LiDAR device is determined using a combination of the presence or the absence of the reflection light intensity change and the presence or the absence of the background light intensity change.

### BRIEF DESCRIPTION OF THE DRAWINGS

FIG. 1 is a diagram showing an example of a schematic configuration of a vehicle system.

FIG. 2 is a diagram showing an example of a schematic configuration of an image processing device.

FIG. 3 is a flowchart showing an example of a flow of an abnormality determination related process by a processor.

FIG. 4 is a flowchart showing an example of a flow of a no-change case process by the processor.

FIG. 5 is a diagram showing an example of a schematic configuration of a vehicle system.

FIG. 6 is a diagram showing an example of a schematic configuration of an image processing device.

FIG. 7 is a flowchart showing an example of a flow of an abnormality determination related process by a processor.

FIG. 8 is a diagram showing an example of a schematic configuration of a vehicle system.

FIG. 9 is a diagram showing an example of a schematic configuration of an image processing device.

FIG. 10 is a schematic diagram showing a configuration of a vehicle system.

FIG. 11 is a diagram showing an example of a schematic configuration of an image processing device.

FIG. 12 is a flowchart showing an example of a flow of an abnormality determination related process by a processor.

FIG. 13 is a flowchart showing an example of a flow of a no-change case process by the processor.

### DETAILED DESCRIPTION

Although, in the technology of the comparative example, it is possible to determine an abnormality regarding at least one of the light receiver or the light emitter of the LiDAR device, it is not possible to distinguish and determine the details thereof.

One example of the present disclosure provides an abnormality determination device, an abnormality determination method, and a non-transitory computer-readable storage medium storing an abnormality determination program capable of determining more details of a LiDAR device.

According to one example of the present disclosure, an abnormality determination device includes: an image acquisition portion configured to acquire: a reflection light image representing intensity distribution of reflection light that is obtained by reflection of light irradiated by a light emitter towards a detection area and detected by a light reception element of a light detection and ranging (LiDAR) device; and a background light image representing intensity distribution of environment light that is in the detection area, does not include the reflection light, and is detected by the light reception element; a change identification unit configured to identify presence or absence of a reflection light intensity change that is a change in a light intensity of the reflection light image for a predetermined time and presence or absence of a background light intensity change that is a change in a light intensity of the background light image for the predetermined time, from the reflection light image and the background light image sequentially acquired by the image acquisition unit; and an abnormality determination unit configured to determine an abnormality type of the LiDAR device using a combination of the presence or the absence of the reflection light intensity change and the presence or the absence of the background light intensity change that are identified by the change identification unit.

Further, according to another example of the present disclosure, an abnormality determination method includes: acquiring: a reflection light image representing intensity distribution of reflection light that is obtained by reflection of light irradiated by a light emitter towards a detection area and detected by a light reception element of a light detection and ranging (LiDAR) device; and a background light image representing intensity distribution of environment light that is in the detection area, does not include the reflection light, and is detected by the light reception element; identifying presence or absence of a reflection light intensity change that is a change in a light intensity of the reflection light image for a predetermined time and presence or absence of a background light intensity change that is a change in a light intensity of the background light image for the predetermined time, from the sequentially acquired reflection light image and the sequentially acquired background light image; and determining an abnormality type of the LiDAR device using a combination of the presence or the absence of the identified reflection light intensity change and the presence or the absence of the identified background light intensity change.

Further, according to another example of the present disclosure, a non-transitory computer-readable storage medium stores an abnormality determination program configured to cause at least one processor to: acquire: a reflection light image representing intensity distribution of reflection light that is obtained by reflection of light irradiated by a light emitter towards a detection area and detected by a light reception element of a light detection and ranging (LiDAR) device; and a background light image representing intensity distribution of environment light that is in the detection area, does not include the reflection light, and is detected by the light reception element; identify presence or absence of a reflection light intensity change that is a change in a light intensity of the reflection light image for a predetermined time and presence or absence of a background light intensity change that is a change in a light intensity of the background light image for the predetermined time, from the sequentially acquired reflection light image and the sequentially acquired background light image; and determine an abnormality type of the LiDAR device using a combination of the presence or the absence of the identified reflection light intensity change and the presence or the absence of the identified background light intensity change.

According to this, the type of abnormality of the LiDAR device is separately determined using the presence or absence of a change (background light intensity change, reflection light intensity change) in the respective light intensities of a background light image and a reflection light image for a detection area for the predetermined time. The background light intensity change and the reflection light intensity change are changes in the light intensity of the background light image and reflection light image for a predetermined time. Therefore, based on the presence or absence of this change, it is possible to determine whether there is an abnormality in the member used to obtain the background light image and the reflection light image. Further, while the background light image represents the intensity distribution of environmental light, the reflection light image represents the intensity distribution of the reflection light of the light emitted by the light emitter. Therefore, a combination of the presence or absence of reflection light intensity change and the presence or absence of background light intensity change is used. Thereby, it is possible to determine the abnormality by distinguishing whether the abnormality is in a different member or a common member in the LiDAR device used to obtain the background light image and the reflection light image. As a result, it becomes possible to determine the abnormality of the LiDAR device in more detail.

A plurality of embodiments will be described with reference to the drawings.

### (Schematic Configuration of Vehicle System 1)

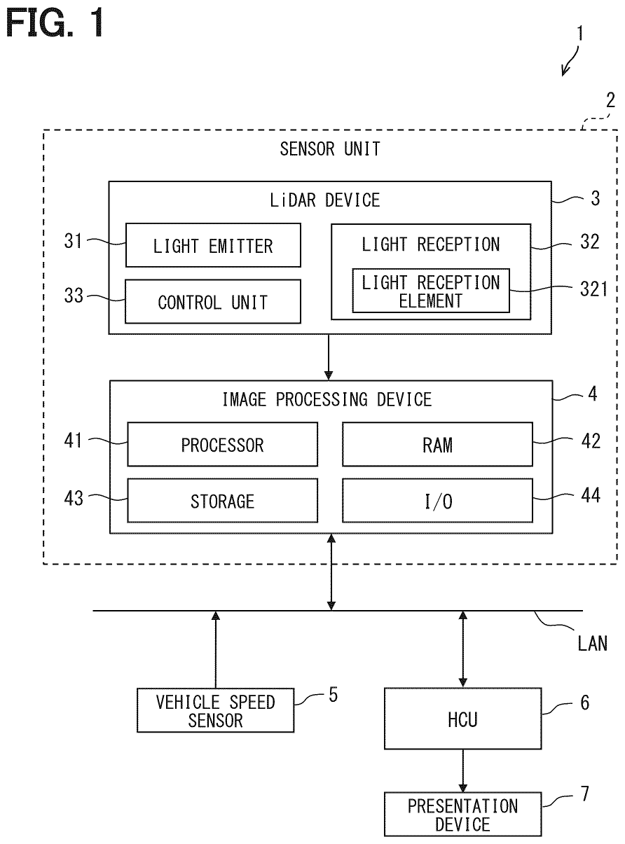

A vehicle system 1 can be used for a vehicle. As shown in FIG. 1, the vehicle system 1 includes a sensor unit 2, a vehicle speed sensor 5, an HCU (Human Machine Interface Control Unit) 6, and a presentation device 7. For example, the sensor unit 2, the vehicle speed sensor 5, and the HCU 6 may be connected to an in-vehicle LAN (see LAN in FIG. 1). Although the vehicle using the vehicle system 1 is not necessarily limited to an automobile, hereinafter, an example using the automobile will be described. Hereinafter, the vehicle using the vehicle system 1 is referred to as a subject vehicle.

The vehicle speed sensor 5 detects the speed of the subject vehicle. The HCU 6 mainly includes a computer including a processor, a volatile memory, a nonvolatile memory, an 1/O, and a bus connecting these devices. The HCU 6 executes various processing related to an interaction between an occupant and a system of the subject vehicle by executing a control program stored in the nonvolatile memory.

The presentation device 7 is mounted on the subject vehicle and presents information to the interior of the subject vehicle. The presentation device 7 performs the information presentation according to an instruction from the HCU 6. The presentation device 7 may at least present the information to the driver. The presentation device 7 may further present the information to a passenger other than the driver. Examples of the presentation device 7 include a display, an audio output device, and the like.

The display device performs the information presentation by displaying the information. As the display device, for example, a meter MID (Multi Information Display), CID (Center Information Display), HUD (Head-Up Display) can be used. The meter MID is a display device located in front of the driver seat in the vehicle compartment. As an example, the meter MID may be provided in a meter panel. The CID is a display device disposed at a center of an instrument panel of the subject vehicle. The HUD is provided in, for example, the instrument panel in the vehicle compartment. The HUD projects a display image formed by a projector onto a projection region defined in a front windshield serving as a projection member. Light reflected from an image to a vehicle interior side by the front windshield is perceived by a driver seated in the driver's seat. Accordingly, the driver can visually recognize a virtual image of the display image formed in front of the front windshield in an overlapping manner with a part of the foreground. The HUD may project the display image onto a combiner provided in front of the driver's seat instead of the front windshield. The audio output device presents information by outputting audio. Examples of the audio output device include a speaker.

The sensor unit 2 includes a LiDAR (light detection and ranging) device 3 and an image processing device 4, as shown in FIG. 1. The sensor unit can also be referred to as a sensor package. The LiDAR device 3 is an optical sensor that irradiates light onto a predetermined area in a periphery of the subject vehicle and detects the reflection light that is reflected by a target object. This predetermined range can be set arbitrarily. Hereinafter, the range to be measured by the LiDAR device 3 will be referred to as a detection area. The LiDAR device 3 may be a SPAD (Single Photon Avalanche Diode) LiDAR. A schematic configuration of the LiDAR device 3 will be described later.

The image processing device 4 is connected to the LiDAR device 3. The image processing device 4 acquires image data such as a reflection light image and a background light image, which will be described later and output from the LiDAR device 3, and detects the target object from these image data. Further, the image processing device 4 distinguishes and determines the type of abnormality in the LiDAR device 3 from these image data. Hereinafter, a configuration will be described in which the image processing device 4 distinguishes and determines the types of abnormalities in the LiDAR device 3. A schematic configuration of the image processing device 4 will be described later.

### (Schematic Configuration of LiDAR Device 3)

Here, the schematic configuration of the LiDAR device 3 will be described using FIG. 1. As shown in FIG. 1, the LiDAR device 3 includes a light emitter 31, a light receiver 32, and a control unit 33.

The light emitter 31 emits a light beam from a light source toward the detection area by scanning the detection area using a movable optical member. An example of the movable optical member is a polygon mirror. For example, a semiconductor laser may be used as the light source. Note that the LiDAR device 3 is not limited to a mechanical rotation type, and may be a MEMS mirror type. The light emitter 31 emits, for example, a light beam in a non-visible region in a pulsed manner in response to an electric signal from the control unit 33. The non-visible region is a wavelength region that is invisible to humans. As an example, the light emitter 31 may emit a light beam in the near-infrared region as the light beam in the non-visible region.

The light receiver 32 has a light reception element 321. Note that the light receiver 32 may also have a condensing lens. The condenser lens gathers the reflection light of the light beam reflected by the target object in the detection area and the background light relative to the reflection light, and controls the gathered light to enter the light reception element 321. The light reception element 321 is an element configured to convert the light into an electric signal by photoelectric conversion. The light reception element 321 is assumed to have sensitivity in the non-visible region. As the light reception element 321, a CMOS sensor may be used. The CMOS sensor has a high sensitivity in the near infrared region compared with the visible region for efficiently detecting the reflection light of the light beam. The sensitivity of the light reception element 321 to each wavelength range may be adjusted by an optical filter. The light reception element 321 may have multiple light reception pixels arranged as an array in one-dimensional direction or two-dimensional directions. Each light reception pixel may have a configuration using SPAD. This light reception pixel has a configuration, and amplifies the electrons generated by the incident of photons by avalanche multiplication. Thereby, it is possible to enable highly sensitive photodetection.

The control unit 33 controls operations of the light emitter 31 and the light receiver 32. The control unit 33 may be placed on a common substrate with the light reception element 321, for example. The control unit 33 mainly includes a processor in a broad sense such as a microcontroller or an FPGA (Field-Programmable Gate Array). The control unit 33 has a scanning control function, a reflection light measuring function, and a background light measuring function.

The scanning control function is a function for controlling scanning of light beam by the light emitter 31. The control unit 33 oscillates the light beam emitted from the light source multiple times to have a pulse shape based on an operating clock of a clock oscillator included in the LiDAR device 3. In addition, the control unit 33 operates the movable optical member in synchronization with the emission of the light beam.

The reflection light measurement function is a function of reading out, according to the scan timing of the light beam, a voltage value corresponding to the reflection light received by each light reception pixel, and measuring an intensity of the reflection light. The control unit 33 is configured to sense the arrival time of the reflection light based on the timing when a peak appears in the output pulse of the light reception element 321. The control unit 33 measures the flight time of the light (Time of Flight) by measuring the time difference between the time when the light beam is emitted from the light source and the time when the reflection light arrives.

By the cooperation of the above scanning control function and the reflection light measuring function, the reflection light image, which is image-like data, is generated. The control unit 33 may measure the reflection light by the rolling shutter method to generate the reflection light image. The details will be described as follows. The control unit 33 generates, according to the scanning of the light beam in a horizontal direction, information of pixel group aligned in a transverse direction on an imaging plane corresponding to the detection area, one or more lines at a time. The control unit 33 generates one reflection light image by longitudinally synthesizing the pixel information sequentially generated for each line.

The reflection light image is image data including distance information obtained when the light reception element 321 detects reflection light corresponding to light irradiation from the light emitter 31. The value indicating the flight time of the light is contained in each pixel of the reflection light image. The value indicating the flight time of light can also be rephrased as a distance value indicating the distance from the LiDAR device 3 to the reflection point of an object located in the detection area. Further, the value indicating the intensity of the reflection light is contained in each pixel of the reflection light image. The intensity distribution of the reflection light may be converted into data as brightness distribution by gradation. That is, the reflection light image is image data representing brightness distribution of the reflected light. The reflection light image can also be referred to as an image in which the intensity of reflection light from the target object is converted into pixel values.

The background light measurement function is a function of reading out a voltage value corresponding to the environmental light received by each light reception pixel at a time point immediately before measurement of the reflection light, and measuring the intensity of the environmental light. The term “environmental light” as used herein means incident light that is incident on the light reception element 321 from the detection area and does not substantially include reflection light. The incident light includes natural light, light from an external display, and the like. Hereinafter, the environmental light will be referred to as background light. The background light image can also be referred to as an image in which the brightness of the surface of the target object is converted into pixel values.

Similar to the reflection light image, the control unit 33 measures the background light by the rolling shutter method and generates the background light image. The intensity distribution of the background light may be converted into data as a brightness distribution by gradation. The background light image is image data representing the brightness distribution of the background light before emitting the light, and contains the brightness information of the background light detected by the light reception element 321 also used for the reflection light image. That is, the value of each pixel arranged tow-dimensionally in the background light image is a brightness value indicating the intensity of the background light at the corresponding portion of the detection area.

The reflection light image and the background light image are sensed by the same light reception element 321, and acquired from the same optical system including the light reception element 321. Accordingly, the coordinate system of the reflection light image can be regarded as the same and coincident coordinate system as the coordinate system of the background light image. In addition, it is assumed that there is almost no difference in measurement timing between the reflection light image and the background light image. Therefore, a set of continuously acquired reflection light images and background light images can be considered to be time-synchronized. Further, the pixels of the reflection light image and the background light image can uniquely correspond to each other. The control unit 33 successively outputs the reflection light image and the background light image to the image processing device 4 as image data in which three data channels including the intensity of the reflection light, the distance to the object, and the intensity of the background light are included for each pixel. Note that the intensity distribution of the reflection light used in the reflection light image is preferably one obtained by subtracting the intensity distribution of the background light in order to remove disturbances caused by the background light. In the present embodiment, an example will be described in which the intensity distribution of reflection light used in the reflection light image is obtained by subtracting the intensity distribution of background light.

### (Schematic Configuration of Image Processing Device 4)

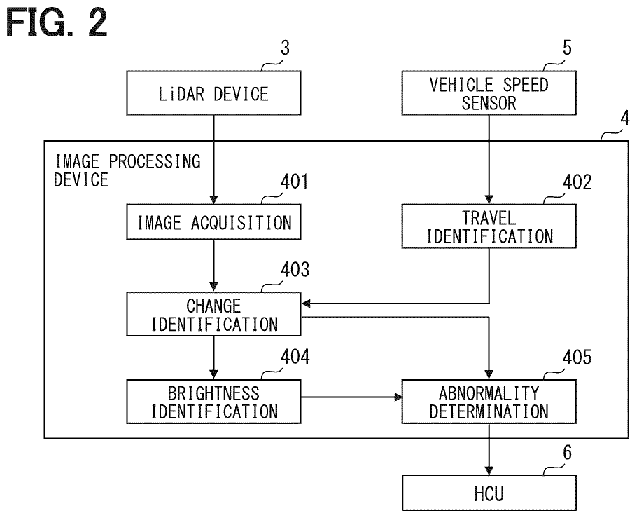

Next, the schematic configuration of the image processing device 4 will be described with reference to FIGS. 1 and 2. As shown in FIG. 1, the image processing device 4 is an electronic control unit that mainly includes an arithmetic circuit including a processor 41, a RAM 42, a storage 43, and an input/output interface (hereinafter referred to as I/O) 44. The processor 41, the RAM 42, the storage 43, and the I/O 44 may be connected via a bus.

The processor 41 is provided by hardware circuit and executes a calculation process in cooperation with the RAM 42. The processor 41 includes at least one calculation core, such as a central processing unit (CPU), a Graphical Processing Unit (GPU), and a FPGA. The processor 41 may be an image processing chip including an IP core or the like having another dedicated function. The image processing chip may be an ASIC (Application Specific Integrated Circuit) designed for the automated driving. The processor 41 executes, by accessing the RAM 42, various processes for functioning as the functional blocks described later.

The storage 43 includes a non-volatile storage medium. This storage medium is a non-transitory tangible storage medium that non-transiently stores computer-readable programs and data. The non-transitory tangible storage medium is implemented by a semiconductor memory, a magnetic disk, or the like. The storage 43 stores various programs such as an abnormality determination program executed by the processor 41.

As shown in FIG. 2, the image processing device 4 includes an image acquisition unit 401, a travel identification unit 402, a change identification unit 403, a brightness identification unit 404, and an abnormality determination unit 405 as functional blocks for determining an abnormality in the LiDAR device 3. This image processing device 4 corresponds to an abnormality determination device. Execution of a process of each functional block of the image processing device 4 by the computer corresponds to execution of an abnormality determination method. A part or all of the functions executed by the image processing device 4 may be configured in hardware by one or multiple ICs or the like. A part or all of the functional blocks included in the image processing device 4 may be implemented by a combination of execution of software by a processor and hardware members.

The image acquisition unit 401 sequentially acquires reflection light images and background light images output from the LiDAR device 3. In other words, the image acquisition unit 401 acquires the reflection light image and the background light image. The reflection light image represents the intensity distribution of the reflection light obtained by detection of the reflection light, which is the light reflected in the detection area, by the light reception element 321. The background light image represents the intensity distribution of the environment light obtained by detection of the environmental light that does not include the reflection light in the detection area by the light reception element 321. This process by the image acquisition unit 401 corresponds to an image acquisition process.

In the present embodiment, the image acquisition unit 401 acquires the reflection light image representing the intensity distribution of the reflection light obtained by detecting the reflection light of the light irradiated on the detection area with the light reception element 321 having sensitivity in the non-visible region, and the background light image representing the intensity distribution of the environmental light obtained by detecting the environmental light in the detection area that does not include the reflection light with the light reception element 321 at a timing different from the detection of the reflection light. The different timing referred to here is a timing that does not completely match the timing at which reflection light is measured, but is slightly shifted to the extent so that it can be considered that the reflection light image and the background light image are synchronized. That is, the image acquisition unit 401 acquires the above-described reflection light image and background light image, which are synchronized in time, by linking them to each other.

The travel identification unit 402 determines whether the subject vehicle is traveling. This travel identification unit 402 corresponds to a movement identification unit. The travel identification unit 402 may determine whether the subject vehicle is traveling based on the vehicle speed detected by the vehicle speed sensor 5. Note that the travel identification unit 402 may determine whether the subject vehicle is traveling based on information other than the vehicle speed detected by the vehicle speed sensor. For example, it may be determined whether the subject vehicle is traveling based on an engine rotation speed, a rotation speed of a travel drive motor, and the like.

The change identification unit 403 identifies the presence or absence of the change (hereinafter, reflection light intensity change) in the light intensity of the reflection light image for a predetermined time and the presence or absence of the change (hereinafter, background light intensity change) in the light intensity of the background light image for the predetermined time, based on the reflection light image and the background light image sequentially acquired by the image acquisition unit 401. This process by the change identification unit 403 corresponds to a change identification process. The predetermined time here may be any value that can be set suitably. The unit for identifying the reflection light intensity change and the background light intensity change may be a pixel unit or a region unit consisting of a plurality of pixels. It is assumed that the changes in reflection light intensity and background light intensity are identified for each pixel and region that are linked to each other. It is preferable to identify changes in the reflection light intensity and background light intensity for each region unit in order to suppress the influence of pixel flickering and improve robustness. Note that the area unit may be a unit of several pixels. The change identification unit 403 identifies whether there is a change in the light intensity obtained by subtracting the light intensity of the background light image from the light intensity of the reflection light image, as the presence or absence of a change in the reflection light intensity.

The change identification unit 403 may identify the presence or absence of a change in the light intensity based on whether the amount of change in light intensity is equal to or greater than a threshold. This threshold may be a value that distinguishes between a value within an error range where there is almost no change in light intensity and a value above the error range. Note that the threshold value for determining whether there is the change in the reflection light intensity and the threshold value for determining whether there is the change in the background light intensity may be different values.

It is preferable that the change identification unit 403 identifies the presence or absence of the change in the intensity of reflection light and the presence or absence of the change in the intensity of background light for a predetermined time of a period during which the subject vehicle is identified by the travel identification unit 402 as being traveling. According to this, the accuracy of identifying the presence or absence of the change in reflection light intensity and the presence or absence of the change in background light intensity becomes higher. The details will be described as follows. When the subject vehicle is traveling, the target within the detection area of the LiDAR device 3 moves. Therefore, when there is the change in the light intensity of the reflection light image and the background light image, the change is identified to be larger. Accordingly, when the subject vehicle is traveling, the difference between the presence or absence of a change in light intensity tends to increase, and it becomes possible to identify the presence or absence of the change in light intensity with higher accuracy.

The brightness identification unit 404 identifies the level of brightness of each of the reflection light image and the background light image acquired by the image acquisition unit 401. The brightness identification unit 404 may identify the level of brightness of each of the reflection light image and the background light image used by the change identification unit 403 to identify the reflection light intensity change and the background light intensity change.

For example, based on time-series data of the reflection light images used by the change identification unit 403 to identify changes in reflected light intensity, the average value of brightness is calculated in units of identified changes in reflected light intensity. When it is a pixel unit, the average value for each pixel is calculated. When it is a region unit, the average value for each region is calculated. Then, when the calculated average value is greater than or equal to the threshold, the brightness of the reflection light image is determined to be high. On the other hand, when the calculated average value is less than the threshold, the brightness of the reflection light image is determined to be low. Further, based on time-series data of the background light images used by the change identification unit 403 to identify changes in background light intensity, the average value of brightness is calculated in units of identified changes in background light intensity. Then, when the calculated average value is greater than or equal to the threshold, the brightness of the background light image is determined to be high. On the other hand, when the calculated average value is less than the threshold, the brightness of the background light image is determined to be low. It is assumed that the threshold value used to specify the level of brightness of the reflection light image is different from the threshold value used to identify the level of brightness of the background light image. These threshold values may be set arbitrarily.

When the brightness identification unit 404 identifies the level of brightness of the reflection light image on a pixel basis, the brightness identification unit 404 may execute the following process. The brightness identification unit 404 may determine that the brightness of the reflection light image is high when the pixel identified as having high brightness is equal to or higher than the pixel identified as having low brightness. On the other hand, the brightness identification unit 404 may determine that the brightness of the reflection light image is low when the pixel identified as having high brightness is less than the pixel identified as having low brightness. When the brightness identification unit 404 determines the level of brightness of the reflection light image in units of regions, the brightness identification unit 404 may execute the following process. The brightness identification unit 404 may determine that the brightness of the reflection light image is high when the region identified as having high brightness is equal to or higher than the region identified as having low brightness. On the other hand, the brightness identification unit 404 may determine that the brightness of the reflection light image is low when the region identified as having high brightness is less than the region identified as having low brightness.

When the brightness identification unit 404 identifies the level of brightness of the background light image on a pixel basis, the brightness identification unit 404 may execute the following process. The brightness identification unit 404 may determine that the brightness of the background light image is high when the pixel identified as having high brightness is equal to or higher than the pixel identified as having low brightness. On the other hand, the brightness identification unit 404 may determine that the brightness of the background light image is low when the pixel identified as having high brightness is less than the pixel identified as having low brightness. When the brightness identification unit 404 determines the level of brightness of the background light image in units of regions, the brightness identification unit 404 may execute the following process. The brightness identification unit 404 may determine that the brightness of the background light image is high when the region identified as having high brightness is equal to or higher than the region identified as having low brightness. On the other hand, the brightness identification unit 404 may determine that the brightness of the background light image is low when the region identified as having high brightness is less than the region identified as having low brightness.

Note that the brightness identification unit 404 may identify the level of brightness of each of the reflection light image and the background light image from a part of the reflection light image and the background light image among the reflection light images and the background light images used by the change identification unit 403 to identify the reflection light intensity change and the background light intensity change.

The abnormality determination unit 405 distinguishes and determines the type of abnormality in the LiDAR device 3 using a combination of the presence or absence of the change in reflection light intensity identified by the change identification unit 403 and the presence or absence of the change in background light intensity. According to this, the type of abnormality of the LiDAR device 3 is separately determined using the presence or absence of a change in the respective light intensities of a background light image and a reflection light image for a detection area for a predetermined time. The background light intensity change and reflection light intensity change are changes in the light intensity of the background light image and reflection light image for a predetermined time. Therefore, based on the presence or absence of this change, it is possible to determine whether there is an abnormality in the member used to obtain the background light image and the reflection light image. Further, while the background light image represents the intensity distribution of environmental light, the reflection light image represents the intensity distribution of the reflection light of the light emitted by the light emitter. Therefore, a combination of the presence or absence of reflection light intensity change and the presence or absence of background light intensity change is used. Thereby, it is possible to determine the abnormality by distinguishing whether the abnormality is in a different member or a common member in the LiDAR device 3 used to obtain the background light image and the reflection light image. As a result, it becomes possible to determine the abnormality of the LiDAR device 3 in more detail. The process in the abnormality determination unit 405 corresponds to an abnormality determination process.

The abnormality determination unit 405 determines that there is no reflection light intensity change by the change identification unit 403. On the other hand, when it is determined that there is the background light intensity change, the type of abnormality may be determined to be a failure of the light emitter 31. This is because when there is no change in the reflection light even though there is a change in the environmental light, it is estimated that light irradiation from the light emitter 31 is not being performed.

It is preferable that the abnormality determination unit 405 distinguishes and determines the abnormality type of the LiDAR device 3 using the combination of level of the reflection light image brightness and the level of background light image brightness identified by the brightness identification unit 404, in addition to the combination of the presence or absence of the reflection light intensity change and the presence or absence of the background light intensity change identified by the change identification unit 403. According to this, it becomes possible to distinguish and determine the abnormality that is difficult to be distinguished and determined only by the combination of the presence or absence of the change in the reflection light intensity and the presence or absence of the change in the background light intensity.

In a case where the change identification unit 403 determines that there is no change in the reflection light intensity or background light intensity, when the brightness identification unit 404 determines that the brightness of the reflection light image is high and but the brightness of the background light image is low, the abnormality determination unit 405 may determine that the abnormality type is dirt on an optical window of the LiDAR device 3. The optical window is positioned between the detection area and the light reception element 321 of the LiDAR device 3. This is because, in a case where there is no change in the environmental light or reflection light, when the brightness of the reflection light is high even though the brightness of the environmental light is low, it is estimated that the irradiation light is reflected by the dirt on the optical window. The optical window is provided in the LiDAR device 3. The optical window is formed of a light-transmitting member that transmits the irradiation light from the light emitter 31 and the reflection light of the irradiation light.

Note that the abnormality determination unit 405 identifies the level of brightness of the reflection light image in units of pixels or regions by the brightness identification unit 404, and distinguishes and determines a type of optical window dirt based on the distribution of pixels or regions whose reflection light image brightness is identified to be high. For example, in a case of a scattered distribution, the type of dirt may be determined to be dust.

In a case where the change identification unit 403 determines that there is no change in the reflection light intensity or background light intensity, when the brightness identification unit 404 determines that the brightness of the reflection light image and the brightness of the background light image are high or low, the abnormality determination unit 405 may determine the abnormality type to be an abnormality in the light reception element 321 of the LiDAR device 3. This is because when there is no change in the environmental light and reflection light and there is no difference in the tendency of the brightness level between the environmental light and the reflection light, it is estimated that there is an abnormality in the light reception element 321 itself.

In the case where the change identification unit 403 determines that there is no change in the reflection light intensity or background light intensity, when the brightness identification unit 404 determines that the brightness of the reflection light image is low and but the brightness of the background light image is high, the abnormality determination unit 405 may determine that there is an excessively bright light source in front of the LiDAR device 3. This is because, in the case where there is no change in the environmental light or reflection light, when the brightness of background light is high even though the brightness of the reflection light is low, it is estimated that the excessively bright light source exists in front of the LiDAR device 3. The excessive bright here may be, for example, a brightness that is estimated to be inappropriate for using the background light image for detecting the target object. The abnormality determination unit 405 may identify the presence of the excessively bright light source in front of the LiDAR device 3 as the abnormality type or as a situation other than abnormality.

The abnormality determination unit 405 may determine that it is a dark place or at night when the change identification unit 403 determines that there is no change in the background light intensity, but that there is a change in the reflection light intensity. This is because when there is no change in background light even though there is the change in reflection light, it is assumed that the situation is in the dark place or at night. The abnormality determination unit 405 may determine that it is the dark place or at night as the abnormality type, or may determine it as a situation other than abnormality.

The abnormality determination unit 405 may determine that there is no abnormality when the change identification unit 403 determines that there is both the change in reflection light intensity and the change in background light intensity. This is because when both the environmental light and the reflection light change, there is highly likely to be no abnormality in the LiDAR device 3.

When the abnormality determination unit 405 determines that there is the abnormality, the abnormality determination result may be sent to the HCU 6 to issue a warning regarding the abnormality. The HCU 6 may issue a warning by causing the presentation device 7 to present information. The warning may be given by displaying an icon, displaying text, outputting audio, or the like. The warning may be given depending on the types of abnormalities that are distinguished and determined by the abnormality determination unit 405. Further, when the abnormality determination unit 405 determines that the type of dirt on the optical window is abnormal, the warning may be issued in accordance with the type of dirt on the optical window. Note that when the abnormality determination unit 405 determines that the situation does not correspond to an abnormality of the LiDAR device 3, information regarding the determined situation may be presented. In addition, it may be used to determine the reliability of detection of the target object by the LiDAR device 3.

### (Abnormality Determination Related Process by Processor 41)

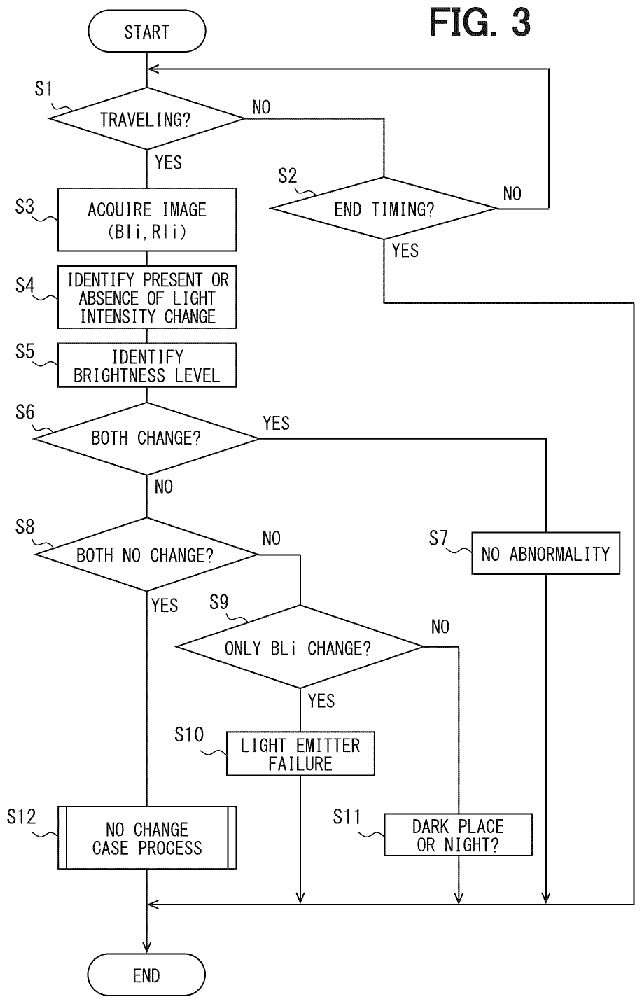

Here, an example of a process (hereinafter referred to as an abnormality determination related process) related to determining an abnormality of the LiDAR device 3 by the processor 41 will be described with reference to a flowchart of FIG. 3. The flowchart shown in FIG. 3 may start, for example, in a state where a switch for starting an internal combustion engine or a motor generator of the subject vehicle (hereinafter, referred to as a power switch) is turned on. Note that the process may start periodically while the power switch is turned on.

First, in S1, when the travel identification unit 402 determines that the subject vehicle is traveling (YES in S1), the process shifts to S3. On the other hand, when the travel identification unit 402 determines that the subject vehicle is stopped (NO in S1), the process shifts to S2.

In S2, when it is the end timing of the abnormality determination related process (YES in S2), the abnormality determination related process ends. On the other hand, when it is not the end timing of the abnormality determination related process (NO in S2), the process returns to S1 and repeats the process. An example of the end timing of the abnormality determination related process is when the power switch of the subject vehicle is turned off.

In S3, the image acquisition unit 401 acquires the reflection light image and the background light image output from the LiDAR device 3. In the drawings, the background light image is shown as Bli, and the reflection light image is shown as Rli.

In S4, the change identification unit 403 identifies the presence or absence of the change (that is, reflection light intensity change) in the light intensity of the reflection light image for a predetermined time and the presence or absence of the change (that is, background light intensity change) in the light intensity of the background light image for the predetermined time, based on the reflection light image and the background light image sequentially acquired in S3. In S5, the brightness identification unit 404 uses the reflection light image and the background light image in which the presence or absence of the light intensity change has been determined in S4 to identify the level of each brightness.

In S6, when it is determined in S4 that there is both the change in reflection light intensity and the change in background light intensity (YES in S6), the process shifts to S7. On the other hand, when it is determined in S4 that there is no change in reflection light intensity or background light intensity (NO in S6), the process shifts to S8. In S7, the abnormality determination unit 405 determines that there is no abnormality, and the abnormality determination related process ends.

In S8, when it is determined in S4 that there is not both the change in reflection light intensity and the change in background light intensity (YES in S8), the process shifts to S12. On the other hand, when it is determined in S4 that there is no change in only one of the reflection light intensity and the background light intensity (NO in S8), the process shifts to S9.

In S9, when it is determined in S4 that there is only the background light intensity change among the background light intensity change and the reflection light intensity change (YES in S9), the process shifts to S10. On the other hand, when it is determined in S4 that there is only the reflection light intensity change among the background light intensity change and the reflection light intensity change (NO in S9), the process shifts to S11.

In S10, the abnormality determination unit 405 determines that the light emitter 31 has failed, and the abnormality determination related process ends. On the other hand, in S11, the abnormality determination unit 405 determines that it is a dark place or night time, and the abnormality determination related process ends. In S11, the abnormality determination unit 405 may determine that there is no abnormality, and the abnormality determination related process may end.

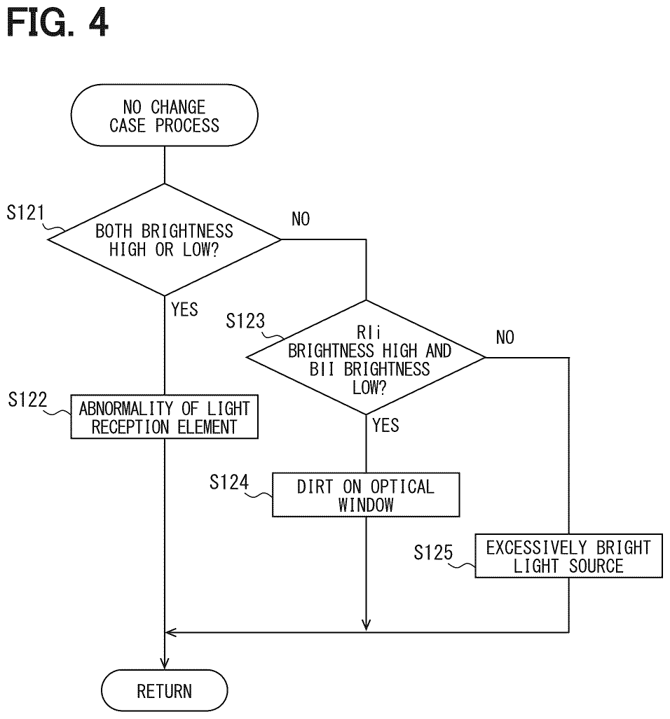

In S12, a no-change case process is executed, and the abnormality determination related process ends. Here, an example of the flow of the no-change case process will be described using the flowchart of FIG. 4.

First, in S121, when the brightness identification unit 404 determines that the brightness of both the reflection light image and the background light image is high or low (YES in S121), the process shifts to S122. On the other hand, when the brightness level of the reflection light image and the background light image determined by the brightness identification unit 404 are different between the reflection light image and the background light image (NO in S121), the process shifts to S123. In S122, the abnormality determination unit 405 determines that the light reception element 321 has the abnormality, and the abnormality determination related process ends.

In S123, when the brightness identification unit 404 determines that the brightness of the reflection light image is high and the brightness of the background light image is low (YES in S123), the process shifts to S124. On the other hand, when the brightness identification unit 404 determines that the brightness of the reflection light image is low and the brightness of the background light image is high (YES in S123), the process shifts to S125.

In S124, the abnormality determination unit 405 determines that the type of abnormality is dirt on the optical window of the LiDAR device 3, and the abnormality determination related process ends. On the other hand, in S125, the abnormality determination unit 405 determines that there is the excessively bright light source in front of the LiDAR device 3, and the abnormality determination related process ends. In S125, the abnormality determination unit 405 may determine that there is no abnormality, and the abnormality determination related process may end.

Note that when the process in S6 is executed before the process in S5 and it is determined in S4 that there is both the reflection light intensity change and the background light intensity change, the process by the brightness identification unit 404 may be omitted. According to this, it becomes possible to reduce unnecessary processing in the brightness identification unit 404. (Overview of First Embodiment)

According to the configuration of the first embodiment, as described above, by using a combination of the presence or absence of the reflection light intensity change and the presence or absence of the background light intensity change, it is possible to determine the abnormality of the LiDAR device 3 in more detail.

Further, according to the configuration of the first embodiment, since a SPAD is used for the light reception element 321, the reflection light image can be obtained. The common light receiving element 321 makes it possible to also obtain the background light image. Further, according to the configuration of the first embodiment, since the reflection light image and the background light image are obtained by the common light reception element 321, it is possible to reduce the time synchronization between the reflection light image and the background light image and calibration effort.

### Second Embodiment

The embodiment described above has shown the configuration in which the change identification unit 403 identifies the presence or absence of the reflection light intensity change and the background light intensity change only when the travel identification unit 402 determines that the subject vehicle is traveling. However, the present disclosure is not limited to the configuration. For example, a configuration (hereinafter referred to as a second embodiment) may be employed in which the travel identification unit 402 switches the length of a predetermined time when identifying the reflection light intensity change and the background light intensity change depending on whether the subject vehicle is traveling.

### (Schematic Configuration of Vehicle System 1a)

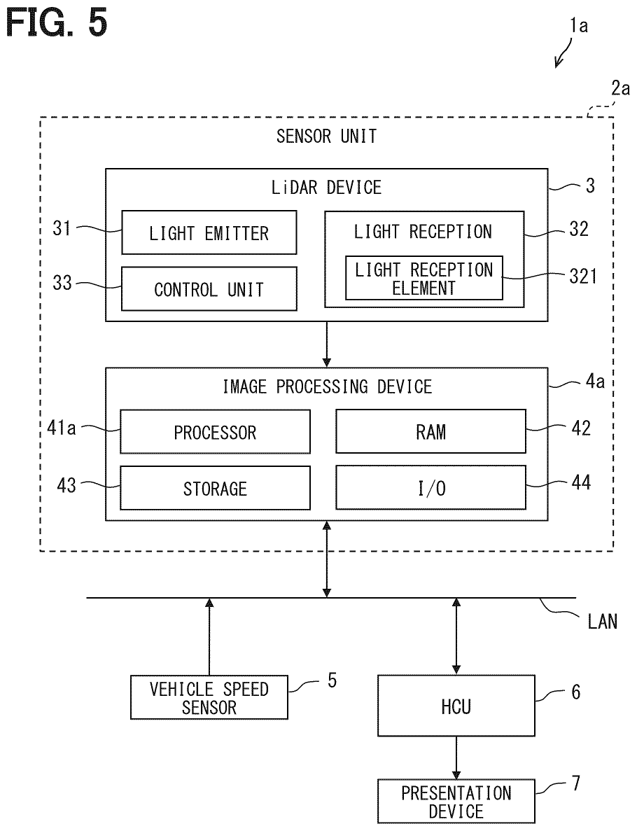

A vehicle system 1a can be used for the vehicle. The vehicle system 1a includes a sensor unit 2a, the vehicle speed sensor 5, the HCU 6, and the presentation device 7, as shown in FIG. 5. The vehicle system 1a is the same as the vehicle system 1 of the first embodiment except that it includes the sensor unit 2a instead of the sensor unit 2. The sensor unit 2a includes the LiDAR device 3, an image processing device 4a, and an external camera 8, as shown in FIG. 5.

### (Schematic Configuration of Image Processing Device 4a)

Next, the schematic configuration of the image processing device 4a will be described with reference to FIG. 5. As shown in FIG. 5, the image processing device 4a is an electronic control unit that mainly includes an arithmetic circuit including a processor 41a, the RAM 42, the storage 43, and the I/O 44. The image processing device 4a is the same as the image processing device 4 of the first embodiment except that it includes the processor 41a instead of the processor 41.

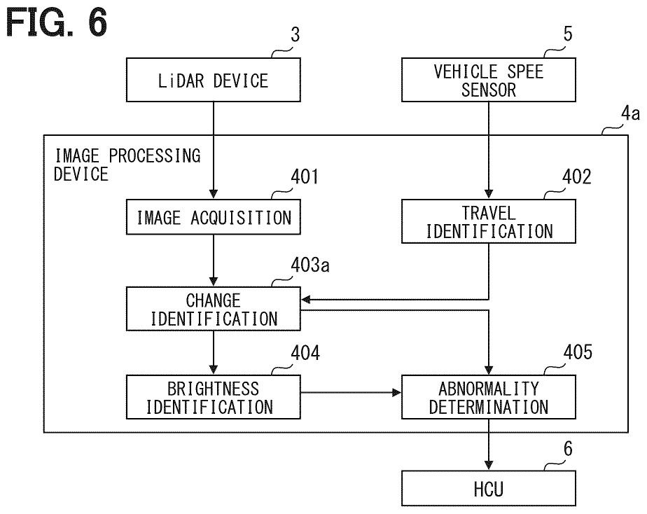

As shown in FIG. 6, the image processing device 4a includes the image acquisition unit 401, the travel identification unit 402, a change identification unit 403a, the brightness identification unit 404, and the abnormality determination unit 405 as functional blocks. This image processing device 4a also corresponds to the abnormality determination device. Execution of a process of each functional block of the image processing device 4a by the computer also corresponds to execution of the abnormality determination method. The functional blocks of the image processing device 4a are the same as those of the image processing device 4 of the first embodiment, except that it includes the change identification unit 403a instead of the change identification unit 403.

When the travel identification unit 402 determines that the subject vehicle is traveling, the change identification unit 403a switches the predetermined time to be shorter than when the travel identification unit 402 determines that the subject vehicle is stopped, and identifies the presence or absence of the reflection light intensity change and the presence or absence of the background light intensity change. According to the configuration described above, the accuracy of identifying the presence or absence of the change in reflection light intensity and the presence or absence of the change in background light intensity becomes higher. The details will be described as follows. When the subject vehicle is traveling, the target within the detection area of the LiDAR device 3 moves. Therefore, when there is the change in the light intensity of the reflection light image and the background light image, the change is identified to be larger even in a shorter time. Accordingly, in the case where the subject vehicle is traveling, even when the predetermined time is switched to be shorter than in the stop state of the vehicle, the difference between the presence or absence of a change in light intensity tends to increase, and it becomes possible to identify the presence or absence of the light intensity change with higher accuracy.

Note that, when the travel identification unit 402 may determine that the subject vehicle is stopped, the change identification unit 403a switches the predetermined time to be longer than when the travel identification unit 402 determines that the subject vehicle is traveling. The travel identification unit 402 may identify the presence or absence of the reflection light intensity change and the presence or absence of the background light intensity change. In the present embodiment, the change identification unit 403a sets a shorter monitoring time and a longer monitoring time as the predetermined time (hereinafter referred to as monitoring time) used to identify the presence or absence of the reflection light intensity change and the presence or absence of the background light intensity change depending on whether the subject vehicle is traveling. The shorter monitoring time and the longer monitoring time may be set arbitrarily as long as the shorter monitoring time is shorter than the longer monitoring time.

### (Abnormality Determination Related Process by Processor 41a)

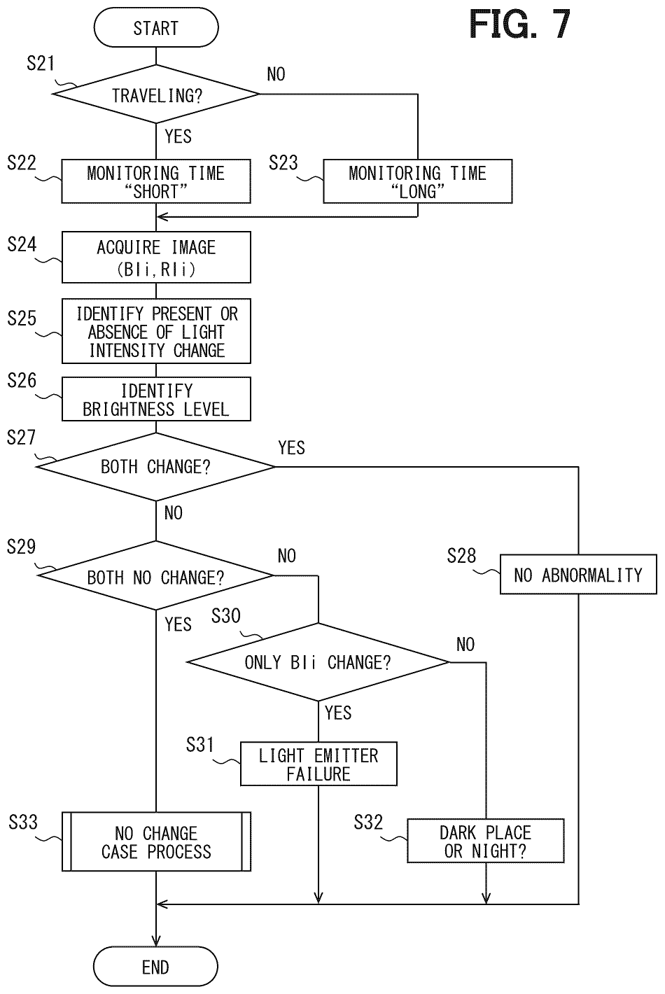

Here, an example of abnormality determination related process by the processor 41a will be described with reference to the flowchart of FIG. 7. Also the flowchart of FIG. 7 may start, for example, in a state where the power switch of the subject vehicle is turned on. Note that the process may start periodically while the power switch is turned on.

First, in S21, when the travel identification unit 402 determines that the subject vehicle is traveling (YES in S21), the process shifts to S22. On the other hand, when the travel identification unit 402 determines that the subject vehicle is stopped (NO in S21), the process shifts to S23.

In S22, the change identification unit 403a sets the monitoring time to be shorter, and the process shifts to S24. On the other hand, in S23, the change identification unit 403a sets the monitoring time to be longer, and the process shifts to S24. In S24, similarly to S3, the image acquisition unit 401 acquires the reflection light image and the background light image output from the LiDAR device 3.

In S25, the change identification unit 403a identifies the presence or absence of the change (that is, reflection light intensity change) in the light intensity of the reflection light image for a predetermined time and the presence or absence of the change (that is, background light intensity change) in the light intensity of the background light image for the predetermined time, based on the reflection light image and the background light image sequentially acquired in S24. In S25, the predetermined time set in S22 or S23 is used as this predetermined time.

In S26 to S33, processes same as in S5 to S12 are executed. In addition, the no-change case process in S33 is same as in S12 and executed.

Note that, also in the flowchart of FIG. 7, when the process in S27 is executed before the process in S26 and it is determined in S25 that there is both the reflection light intensity change and the background light intensity change, the process by the brightness identification unit 404 may be omitted.

### (Overview of Second Embodiment)

The configuration of the second embodiment is same as the configuration of the first embodiment, except that the presence or absence of the reflection light intensity change and the background light intensity change is determined even when the subject vehicle is stopped. Accordingly, similarly to the first embodiment, by using a combination of the presence or absence of the reflection light intensity change and the presence or absence of the background light intensity change, it is possible to determine the abnormality of the LiDAR device 3 in more detail.

### Third Embodiment

In the embodiment described above, the configuration is shown in which the reflection light image and the background light image are obtained by the common light reception element 321. However, the present disclosure is not necessarily limited to this configuration. For example, a configuration (hereinafter referred to as a third embodiment) in which the reflection light image and the background light image are obtained by different light reception elements may be used. Hereinafter, the configuration of the third embodiment will be described.

### (Schematic Configuration of Vehicle System 1b)

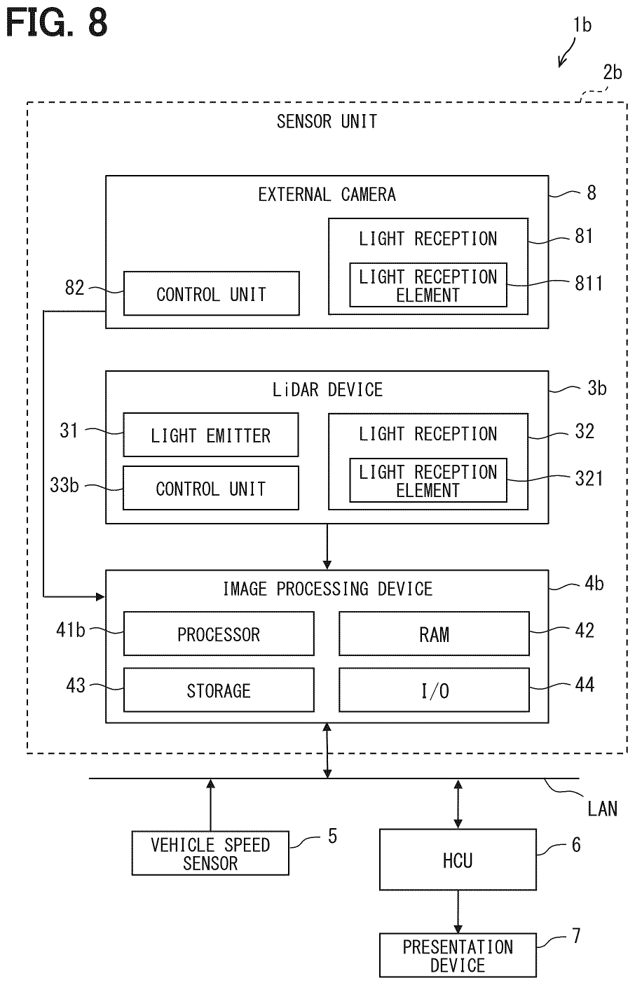

A vehicle system 1b can be used for the vehicle. The vehicle system 1b includes a sensor unit 2b, the vehicle speed sensor 5, the HCU 6, and the presentation device 7, as shown in FIG. 8. The vehicle system 1b is the same as the vehicle system 1 of the first embodiment except that it includes the sensor unit 2b instead of the sensor unit 2. The sensor unit 2b includes a LiDAR device 3b, an image processing device 4b, and the external camera 8, as shown in FIG. 8.

### (Schematic Configuration of LiDAR Device 3b)

As shown in FIG. 8, the LiDAR device 3b includes the light emitter 31, the light receiver 32, and a control unit 33b. The LiDAR device 3b is the same as the LiDAR device 3 of the first embodiment except that it includes the control unit 33b instead of the control unit 33.

The control unit 33b is same as the control unit 33 of the first embodiment except that it does not have the background light measurement function. The light reception element 321 of the LiDAR device 3b may or may not use the SPAD. (Schematic Configuration of External Camera 8)

The external camera 8 captures a predetermined range of the outside field of the subject vehicle. The external camera 8 may be placed, for example, on the interior side of a front windshield of the subject vehicle. It is assumed that the capturing range of the external camera 8 at least partially overlaps the measurement range of the LiDAR device 3b.

The external camera 8 includes a light reception unit 81 and a control unit 82, as shown in FIG. 8. The light reception unit 81 condenses incident light that enters from the capture range using, for example, a light reception lens, and causes the light to enter the light reception element 811. This incident light is the background light. The light reception element 811 can also be referred to as a camera element. The light reception element 811 converts light into an electric signal by photoelectric conversion. For example, a CCD sensor or a CMOS sensor can be adopted as the camera element 22a. The light reception element 811 is set to have high sensitivity in the visible region compared with the near infrared region in order to efficiently receive natural light in the visible region. The light reception element 811 has a plurality of light reception pixels arranged in an array in a two-dimensional direction. For example, red, green, and blue color filters may be arranged on the light reception pixels adjacent to one another. Each light reception pixel receives visible light of one color corresponding to the arranged color filter. By measuring the intensity of red, green, and blue, the camera image taken by the external camera 8 becomes a color image in the visible range. Therefore, the external camera 8 can also be called a color camera. The camera image obtained by the external camera 8 also corresponds to the background light image.

The control unit 82 is a unit that controls the light reception unit 81. The control unit 82 may be placed on a common substrate with the light reception element 811, for example. The control unit 82 mainly includes a broadly defined processor such as a microcomputer or FPGA, for example. The control unit 82 has an image capturing function.

The image capturing function is a function for capturing a color image as described above. The control unit 82 reads out, according to an operating clock of a clock oscillator included in the external camera 8, a voltage value corresponding to the incident light received by each light reception pixel using, for example, a global shutter method, and measures an intensity of the sensed incident light. The control unit 82 can generate, as a camera image, image-like data in which the intensity of incident light is associated with the two-dimensional coordinates on the image plane corresponding to the capture range. Such a camera image is sequentially output to the image processing device 4b.

### (Schematic Configuration of Image Processing Device 4b)

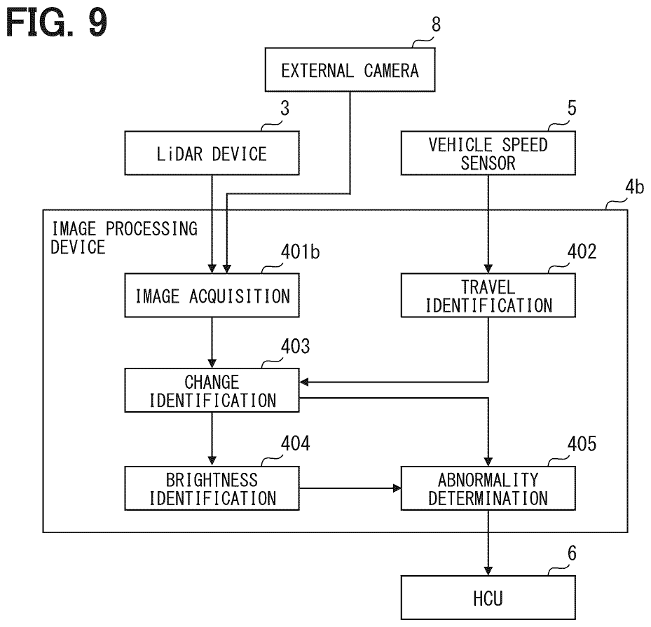

Next, the schematic configuration of the image processing device 4b will be described with reference to FIGS. 8 and 9. As shown in FIG. 8, the image processing device 4b is an electronic control device that mainly includes an arithmetic circuit including a processor 41b, the RAM 42, the storage 43, and the I/O 44. The image processing device 4b is the same as the image processing device 4 of the first embodiment except that it includes the processor 41b instead of the processor 41.

As shown in FIG. 9, the image processing device 4b includes an image acquisition unit 401b, the travel identification unit 402, the change identification unit 403, the brightness identification unit 404, and the abnormality determination unit 405 as functional blocks. This image processing device 4b also corresponds to the abnormality determination device. Execution of a process of each functional block of the image processing device 4b by the computer also corresponds to execution of the abnormality determination method. The functional blocks of the image processing device 4b are the same as those of the image processing device 4 of the first embodiment, except that it includes the image acquisition unit 401b instead of the image acquisition unit 401.

The image acquisition unit 401b sequentially acquires the reflection light image output from the LiDAR device 3b. The image acquisition unit 401b sequentially acquires the camera image output from the external camera 8 as the background light image. The measurement range in which the reflection light image is obtained by the LiDAR device 3b and the capture range in which the background light image is obtained by the external camera 8 partially overlap. This overlapping range is defined as a detection area. Accordingly, the image acquisition unit 401b acquires the reflection light image and the background light image. The reflection light image represents the intensity distribution of the reflection light obtained by detection of the reflection light, which is the light reflected in the detection area, by the light reception element 321 with the sensitivity in the visible region. The background light image represents the intensity distribution of the environment light obtained by detection of the environmental light that does not include the reflection light in the detection area by the light reception element 811 with the sensitivity in a visible region different from that of the light reception element 321. This process by the image acquisition unit 401b also corresponds to the image acquisition process.

Note that, in the image processing device 4b, the reflection light image output from the LiDAR device 3b and the background light image output from the external camera 8 may be time-synchronized using a time stamp or the like. Further, the image processing device 4b also performs calibration according to the deviation between the measurement base point of the LiDAR device 3b and the capturing base point of the external camera 8. Thereby, it is possible to treats the coordinate system of the reflection light image and the coordinate system of the background light image as the same coordinate system. (Overview of Third Embodiment)

The configuration of the third embodiment is same as the configuration of the first embodiment, except for the configuration regarding whether the background light image is obtained by the LiDAR device 3 or the external camera 8. Accordingly, similarly to the first embodiment, by using a combination of the presence or absence of the reflection light intensity change and the presence or absence of the background light intensity change, it is possible to determine the abnormality of the LiDAR device 3 in more detail. Note that the second embodiment and the third embodiment may be combined.

### Fourth Embodiment

In the embodiment described above, the intensity distribution of the reflection light used in the reflection light image is the one obtained by subtracting the intensity distribution of the background light, but the present disclosure is not necessarily limited to this. For example, a configuration (hereinafter, fourth embodiment) may be employed in which the reflection light intensity distribution used in the reflection light image is obtained without subtracting the background light intensity distribution. Hereinafter, the configuration of the fourth embodiment will be described.

### (Schematic Configuration of Vehicle System 1c)

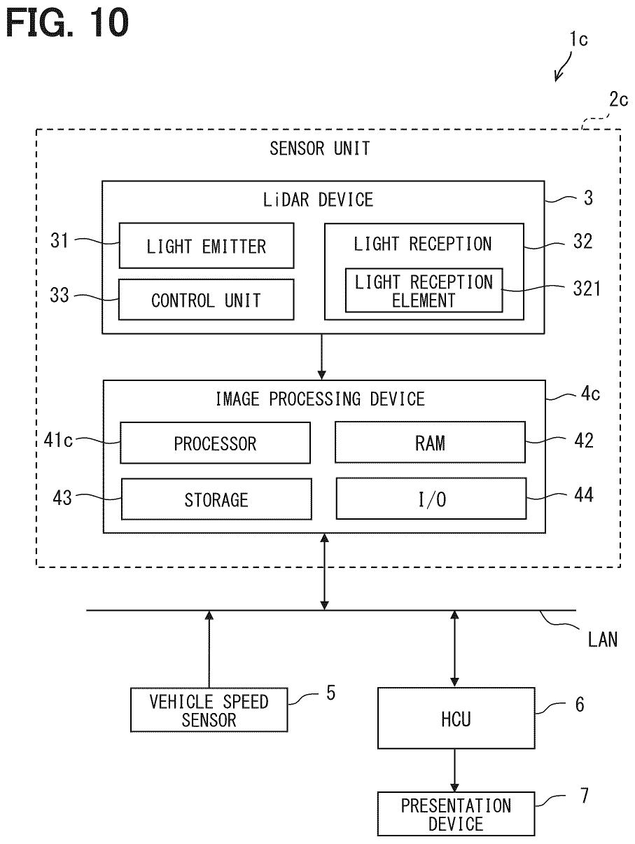

A vehicle system 1c can be used for the vehicle. The vehicle system 1c includes a sensor unit 2, the vehicle speed sensor 5, the HCU 6, and the presentation device 7, as shown in FIG. 10. The vehicle system 1c is the same as the vehicle system 1 of the first embodiment except that it includes the sensor unit 2c instead of the sensor unit 2. The sensor unit 2c includes the LiDAR device 3, an image processing device 4c, and the external camera 8, as shown in FIG. 10.

### (Schematic Configuration of Image Processing Device 4c)

Next, the schematic configuration of the image processing device 4c will be described with reference to FIG. 10. As shown in FIG. 10, the image processing device 4c is an electronic control device that mainly includes an arithmetic circuit including a processor 41c, the RAM 42, the storage 43, and the I/O 44. The image processing device 4c is the same as the image processing device 4 of the first embodiment except that it includes the processor 41c instead of the processor 41.

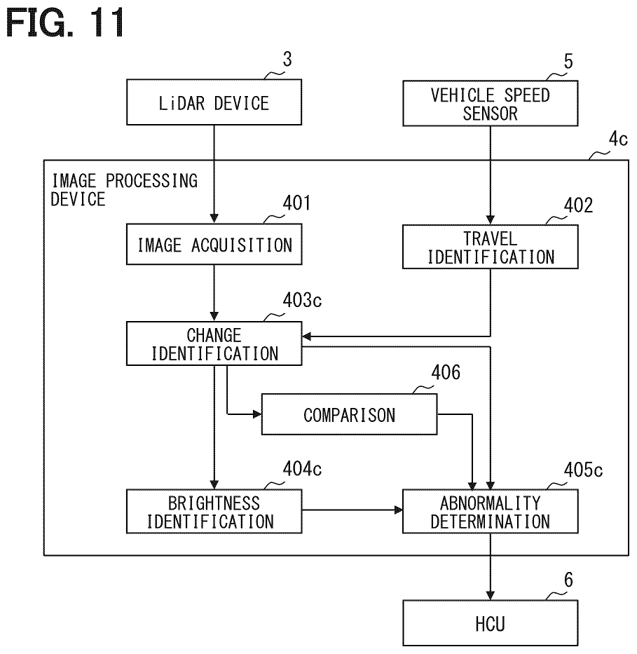

As shown in FIG. 11, the image processing device 4c includes the image acquisition unit 401, the travel identification unit 402, a change identification unit 403c, a brightness identification unit 404c, an abnormality determination unit 405c, and a comparison unit 406 as functional blocks. The functional blocks of the image processing device 4c include the change identification unit 403c instead of the change identification unit 403. The functional blocks of the image processing device 4c include the brightness identification unit 404c instead of the brightness identification unit 404. The functional blocks of the image processing device 4c include the abnormality determination unit 405c instead of the abnormality determination unit 405. The functional blocks of the image processing device 4c include the comparison unit 406. The image processing device 4c is same as the image processing device 4 of the first embodiment except for these points. This image processing device 4c also corresponds to the abnormality determination device. Execution of a process of each functional block of the image processing device 4c by the computer also corresponds to execution of the abnormality determination method.

The change identification unit 403c is same as the change identification unit 403 of the first embodiment, except that some processes are different. This different point will be described below. The change identification unit 403c identifies the presence or absence of the change in the light intensity obtained without subtracting the light intensity of the background light image from the light intensity of the reflection light image, as the presence or absence of a change in the reflection light intensity. In other words, the reflection light image used by the change identification unit 403c also includes brightness information of the background light. According to this, it becomes possible to determine the abnormality of the LiDAR device 3 in more detail while omitting the process of subtracting the brightness information of the background light from the reflection light image. This process by the change identification unit 403c also corresponds to the change identification process.

The brightness identification unit 404c is same as the brightness identification unit 404 of the first embodiment, except that some processes are different. This different point will be described below. The brightness identification unit 404c identifies the brightness level of the reflection light image obtained without subtracting the light intensity of the background light image and the brightness level of the background light image as the level of brightness of each of the reflection light image and the background light image. In other words, the reflection light image used by the brightness identification unit 404c also includes brightness information of the background light. According to this, it becomes possible to determine the abnormality of the LiDAR device 3 in more detail while omitting the process of subtracting the brightness information of the background light from the reflection light image.

The comparison unit 406 determines whether the light intensity of the reflection light image, which is used for identifying the presence or absence of the light intensity change by the change identification unit 403c and obtained without subtracting the light intensity of the background light image, is the same as the light intensity of the background light image. The comparison unit 406 may determine whether the light intensities are substantially the same based on whether the light intensities are substantially the same. For example, a deviation of an error level may be included. For example, the light intensities used by the comparison unit 406 to determine whether the light intensity are the same may be the average value of the light intensities used to identify the presence or absence of the change in the light intensity. Alternatively, the light intensities used by the comparison unit 406 to determine whether they are the same may be a numerical group of light intensities used to identify the presence or absence of the change in the light intensity. In this case, the individual numerical values are successively compared in the group of numerical values of the light intensities. When there is no combination that is not substantially the same, the light intensities may be determined to be the same.

The abnormality determination unit 405c is same as the abnormality determination unit 405 of the first embodiment, except that some processes are different. This different point will be described below. The process in the abnormality determination unit 405c also corresponds to the abnormality determination process. In the fourth embodiment, the reflection light image also includes brightness information of background light. Therefore, in the fourth embodiment, it is assumed that there is no combination in which the change identification unit 403c determines that there is no change in the reflection light intensity and there is the change in the background light intensity.

In the case where the change identification unit 403c determines that there is no change in the reflection light intensity or background light intensity, when the brightness identification unit 404c determines that the brightness of the reflection light image is low and but the brightness of the background light image is high, the abnormality determination unit 405c may determine the abnormality type to be an abnormality in the light reception element 321 of the LiDAR device 3. This is because in the case where there is no change in the environmental light and reflection light, when the light reception element 321 has the abnormality, the background light brightness increases even though the reflection light, which also includes background light brightness information, has low brightness.

In the case where the change identification unit 403c determines that there is no change in the reflection light intensity or background light intensity, when the brightness identification unit 404c determines that both the brightness of the reflection light image and the brightness of the background light image are high, the abnormality determination unit 405c may determine the type of abnormality as an abnormality in the light reception element 321 of the LiDAR device 3 or an abnormality due to the presence of a high brightness light source in the detection area. This is because when there is no change in the environmental light and the reflection light and the brightness of both the environmental light and the reflection light is high, the following two reasons are estimated. The first reason is that it is estimated that the light reception element 321 has the abnormality. The second reason is that it is estimated that both the light intensity of the background light image and the light intensity of the reflection light image, which also includes background light brightness information, are saturated due to the high brightness light source present in the detection area. The presence of the high brightness light source in the detection area corresponds to the presence of the excessively bright light source in front of the LiDAR device 3, as described in the first embodiment.

Note that, in the case where the change identification unit 403c determines that there is no change in the reflection light intensity or background light intensity, when the brightness identification unit 404c determines that both the brightness of the reflection light image and the brightness of the background light image are high, the abnormality determination unit 405c may determine the abnormality type to be only the abnormality of the light reception element 321 of the LiDAR device 3 of the two types described above. That is, the determination may be same as that of the abnormality determination unit 405 of the first embodiment. This is because in the case described here, there is a very low possibility that the abnormality is caused by the presence of a high brightness light source in the detection area. This tendency becomes more noticeable when the subject vehicle is moving. Specifically, this is because when the subject vehicle is moving, there is a particularly low possibility that the excessively bright light source will always remain in front of the LiDAR device 3. Accordingly, in the cases: where the change identification unit 403c determines that there is no change in the reflection light intensity or background light intensity: where the travel identification unit 402 determines that the subject vehicle is traveling; and where the brightness identification unit 404c determines that both the brightness of the reflection light image and the brightness of the background light image are high, the abnormality determination unit 405c may determine the abnormality type to be only the abnormality of the light reception element 321 of the LiDAR device 3 among the two types described above.

In the case where the change identification unit 403c determines that there is the change in the reflection light intensity or background light intensity, when the comparison unit 406 determines that the light intensities of the reflection light image and the background light image are not same, the abnormality determination unit 405c may determine that there is no change. This is because, in a case where both the environmental light and the reflection light including the brightness information of the environmental light change, when these light intensities are not same, there is highly likely to be no abnormality in the LiDAR device 3.

In the case where the change identification unit 403c has determined that there is the change in the reflection light intensity or background light intensity, when the comparison unit 406 determines that the light intensities of the reflection light image and the background light image are same, the abnormality determination unit 405c may determine the abnormality type as the failure of the light emitter 31. This is because, in a case where both the environmental light and the reflection light including the brightness information of the environmental light change, when these light intensities are same, it is estimated that the light emitter 31 is not emitting light. (Abnormality Determination Related Process by Processor 41c)

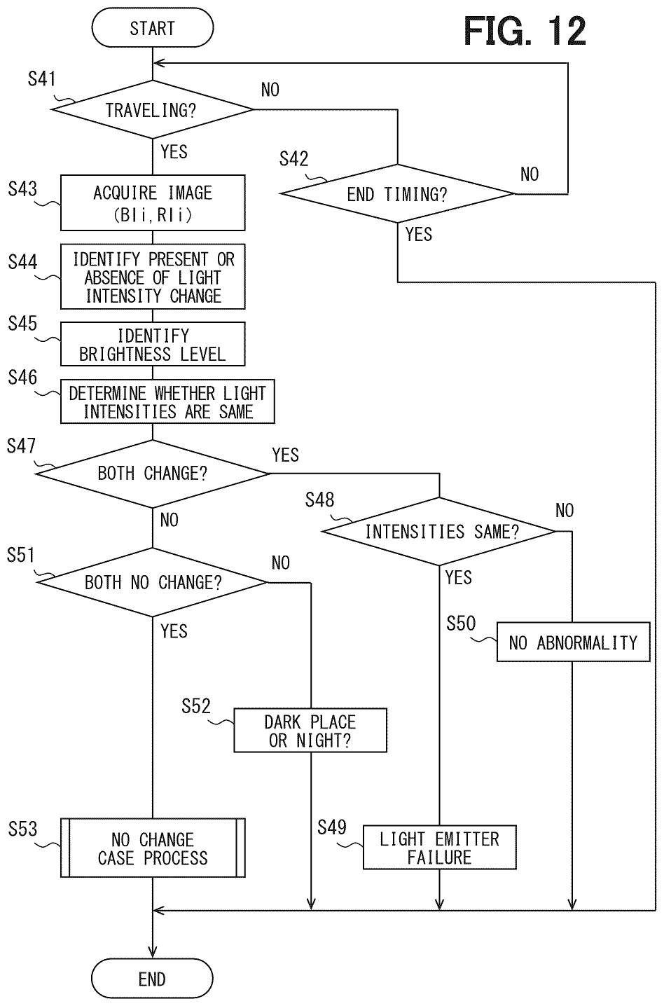

Next, an example of an abnormality determination related process by the processor 41c will be described with reference to the flowchart of FIG. 12. Also the flowchart of FIG. 12 may start, for example, in a state where the power switch of the subject vehicle is turned on. Note that the process may start periodically while the power switch is turned on.

First, in S41, when the travel identification unit 402 determines that the subject vehicle is traveling (YES in S41), the process shifts to S43. On the other hand, when the travel identification unit 402 determines that the subject vehicle is stopped (NO in S41), the process shifts to S42.

In S42, similarly to S2, when it is the end timing of the abnormality determination related process (YES in S42), the abnormality determination related process ends. On the other hand, when it is not the end timing of the abnormality determination related process (NO in S42), the process returns to S41 and repeats the process.

In S43, the image acquisition unit 401 acquires the reflection light image and the background light image output from the LiDAR device 3. In the drawings, the background light image is shown as Bli, and the reflection light image is shown as Rli.

In S44, the change identification unit 403c identifies the presence or absence of the reflection light intensity change for a predetermined time and the presence or absence of the background light intensity change for the predetermined time, based on the reflection light image and the background light image sequentially acquired in S3. As described above, in the fourth embodiment, the reflection light image used by the change identification unit 403c also includes brightness information of the background light. In S45, the brightness identification unit 404c uses the reflection light image and the background light image in which the presence or absence of a change in light intensity has been determined in S44 to identify the level of each brightness. As described above, in the fourth embodiment, also the reflection light image used by the brightness identification unit 404c includes brightness information of the background light.

In S46, the comparison unit 406 determines the reflection light image light intensity obtained without subtracting the background light image light intensity is same as the background light image intensity, using the reflection light image and the background light image whose light intensity change are identified in S44.

In S47, when it is determined in S44 that there is both the change in reflection light intensity and the change in background light intensity (YES in S47), the process shifts to S48. On the other hand, when it is determined in S44 that there is no change in reflection light intensity or background light intensity (NO in S47), the process shifts to S51.

In S48, when it is determined that they are the same in S46 (YES in S48), the process shifts to S49. On the other hand, when it is determined in S46 that they are not the same (NO in S48), the process shifts to S50. In S49, the abnormality determination unit 405c determines that the light emitter 31 has failed, and the abnormality determination related process ends. In S50, the abnormality determination unit 405c determines that there is no abnormality, and the abnormality determination related process ends.

In S51, when it is determined in S44 that there is not both the change in reflection light intensity and the change in background light intensity (YES in S51), the process shifts to S53. On the other hand, when it is determined in S44 that there is no change in only one of the reflection light intensity and the background light intensity (NO in S51), the process shifts to S52.

In S52, the abnormality determination unit 405c determines that it is the dark place or night time, and the abnormality determination related process ends. In the fourth embodiment, as described above, it is assumed that there is no combination in which the change identification unit 403c determines that there is no change in the reflection light intensity and there is the change in the background light intensity.

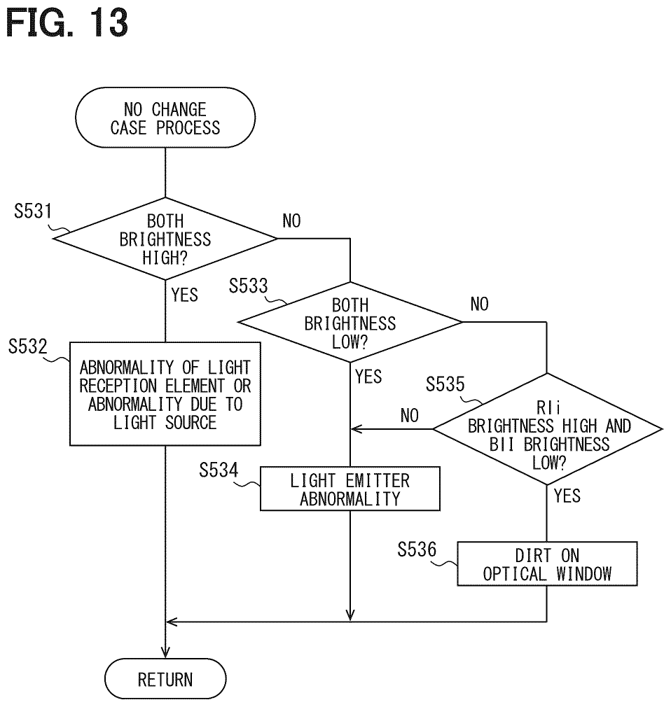

In S53, a no-change case process is executed, and the abnormality determination related process ends. Here, an example of the flow of the no-change case process will be described using the flowchart of FIG. 13.

First, in S531, when the brightness identification unit 404c determines that both the brightness of the reflection light image and the brightness of the background light image are high (YES in S531), the process shifts to S532. On the other hand, when the brightness identification unit 404c identifies that the brightness of at least one of the reflection light image or the background light image is low (NO in S531), the process shifts to S533.

In S532, the abnormality determination unit 405c determines the type of abnormality to be an abnormality in the light reception element 321 of the LiDAR device 3 or an abnormality due to the presence of a high brightness light source in the detection area, and the abnormality determination related process ends.

In S533, when the brightness identification unit 404c determines that both the brightness of the reflection light image and the brightness of the background light image are low (YES in S533), the process shifts to S534. On the other hand, when the brightness level of the reflection light image and the background light image determined by the brightness identification unit 404c are different between the reflection light image and the background light image (NO in S533), the process shifts to S535. In S534, the abnormality determination unit 405c determines that the light reception element 321 has the abnormality, and the abnormality determination related process ends.

In S535, when the brightness identification unit 404c determines that the brightness of the reflection light image is high and the brightness of the background light image is low (YES in S535), the process shifts to S536. On the other hand, when the brightness identification unit 404c determines that the brightness of the reflection light image is low and the brightness of the background light image is high (YES in S535), the process shifts to S534. That is, the abnormality determination unit 405c determines that the light reception element 321 has the abnormality, and the abnormality determination related process ends.

In S536, the abnormality determination unit 405c determines that the type of abnormality is dirt on the optical window of the LiDAR device 3, and the abnormality determination related process ends. Note that when the process in S47 is executed before the process in S45 and it is determined in S44 that there is both the reflection light intensity change and the background light intensity change, the process by the brightness identification unit 404c may be omitted. According to this, it becomes possible to reduce unnecessary processing in the brightness identification unit 404c. Further, when the process in S47 is executed before the process in S46 and it is determined in S44 that there is not both the reflection light intensity change and the background light intensity change, the process by the comparison unit 406 may be omitted. According to this, it becomes possible to reduce unnecessary processing in the comparison unit 406. Alternatively, the processes in S45 and S46 may be executed in a different order or may be performed in parallel.

### (Overview of Fourth Embodiment)

Also according to the configuration of the fourth embodiment, as described above, by using a combination of the presence or absence of the reflection light intensity change and the presence or absence of the background light intensity change, it is possible to determine the abnormality of the LiDAR device 3 in more detail. Further, the configuration of the fourth embodiment and the configurations of the second and third embodiments may be combined.

### Fifth Embodiment

The above-described embodiment has shown a configuration in which the sensor units 2, 2a, 2b, and 2c are provided with the travel identification unit 402. However, the present disclosure is not necessarily limited to this. For example, the sensor units 2, 2a, 2b, and 2c may be provided without the travel identification unit 402. That is, a configuration may be adopted in which the processing does not differ depending on whether the subject vehicle is traveling.

### Sixth Embodiment

In the above-described embodiment, the case where the sensor units 2, 2a, 2b, and 2c are used in a vehicle has been described as an example. However, the present disclosure is not necessarily limited to this. For example, the sensor units 2, 2a, 2b, and 2c may be used on a mobile object other than the vehicle. Examples of the moving body other than the vehicle include a drone. In the case of using the sensor units 2, 2a, 2b, 2c on the mobile object other than the vehicle such as the drone, instead of determining whether the mobile object is traveling based on the detection result of the vehicle speed sensor 5, the detection result of the acceleration sensor may be used to determine whether the mobile object is moving. Further, the sensor units 2, 2a, 2b, and 2c may be used for a stationary object other than the mobile object. Examples of the stationary object include a roadside machine and the like. In a case of using the sensor units 2, 2a, 2b, 2c on the stationary object, the sensor units 2, 2a, 2b, 2c have a function to determine whether the object using the sensor units 2, 2a, 2b, 2c is moving.

It should be noted that the present disclosure is not limited to the embodiments described above, and various modifications are possible within the scope indicated in the claims, and embodiments obtained by appropriately combining technical means disclosed in different embodiments are also included in the technical scope of the present disclosure. Further, the control unit and the method thereof described in the present disclosure may be implemented by a dedicated computer which includes a processor programmed to perform one or more functions executed by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored in a computer-readable non-transitory tangible storage medium as instructions to be executed by a computer.

Here, the process of the flowchart or the flowchart described in this application includes a plurality of sections (or steps), and each section is expressed as, for example, S11. Further, each section may be divided into several subsections, while several sections may be combined into one section. Furthermore, each section thus configured may be referred to as a device, module, or means.

1. An abnormality determination device comprising:
an image acquisition unit configured to acquire:
a reflection light image representing intensity distribution of reflection light that is obtained by reflection of light irradiated by a light emitter towards a detection area and detected by a light reception element of a light detection and ranging (LiDAR) device; and
a background light image representing intensity distribution of environment light that is in the detection area, does not include the reflection light, and is detected by the light reception element;
a change identification unit configured to identify presence or absence of a reflection light intensity change that is a change in a light intensity of the reflection light image for a predetermined time and presence or absence of a background light intensity change that is a change in a light intensity of the background light image for the predetermined time, from the reflection light image and the background light image sequentially acquired by the image acquisition unit; and
an abnormality determination unit configured to determine an abnormality type of the LiDAR device using a combination of the presence or the absence of the reflection light intensity change and the presence or the absence of the background light intensity change that are identified by the change identification unit.

2. The abnormality determination device according to claim 1, wherein
the abnormality determination device is used for a mobile object,
the abnormality determination device further includes a movement identification unit configured to determine whether the mobile object is moving, and
the change identification unit is configured to identify the presence or the absence of the reflection light intensity change that is the change in the light intensity of the reflection light image and the presence or the absence of the background light intensity change that is the change in the light intensity of the background light image for the predetermined time of a period when the movement identification unit has determined that the mobile object is moving.

3. The abnormality determination device according to claim 1, wherein
the abnormality determination device is used for a mobile object,
the abnormality determination device further includes a movement identification unit configured to determine whether the mobile object is moving, and when the movement identification unit has determined that the mobile object is moving, the change identification unit switches the predetermined time to be shorter than when the movement identification unit has determined that the mobile object is stopped, and identifies the presence or the absence of the reflection light intensity change that is the change in the light intensity of the reflection light image and the presence or the absence of the background light intensity change that is the change in the light intensity of the background light image for the predetermined time.

4. The abnormality determination device according to claim 1, wherein
the change identification unit is configured to identify the presence or the absence of the change in a light intensity obtained by subtracting the light intensity of the background light image from the light intensity of the reflection light image, as the presence or the absence of the reflection light intensity change, and
the abnormality determination unit is configured to determine the abnormality type as a failure of the light emitter when the change identification unit has identified the absence of the reflection light intensity change and the presence of the background light intensity change.

5. The abnormality determination device according to claim 1, wherein
the change identification unit is configured to identify the presence or the absence of the change in a light intensity obtained without subtracting the light intensity of the background light image from the light intensity of the reflection light image, as the presence or the absence of the reflection light intensity change,
the abnormality determination device further includes a comparison unit configured to determine whether the light intensity of the reflection light image, which is used for identifying the presence or the absence of the change in the light intensity change by the change identification unit and obtained without subtracting the light intensity of the background light image, is same as the light intensity of the background light image, and
in a case where the change identification unit has identified both the presence of the reflection light intensity change and the presence of the background light intensity change, when the comparison unit has determined that the light intensity of the reflection light image and the light intensity of the background light image are same, the abnormality determination unit determines the abnormality type as a failure of the light emitter.

6. The abnormality determination device according to claim 1, further comprising
a brightness identification unit configured to a level of brightness of each of the reflection light image and the background light image that are acquired by the image acquisition unit,
wherein
the abnormality determination unit determines the abnormality type of the LiDAR device using a combination of the level of the brightness of the reflection light image and the level of the brightness of the background light image that are identified by the brightness identification unit, in addition to the combination of the presence or the absence of the reflection light intensity change and the presence or the absence of the background light intensity change that are identified by the change identification unit.

7. The abnormality determination device according to claim 6, wherein
in a case where the change identification unit identifies the absence of both the reflection light intensity change and the background light intensity change, when the brightness identification unit determines that the brightness of the reflection light image is high and the brightness of the background light image is low, the abnormality determination unit determines that the abnormality type is dirt on an optical window of the LiDAR device, and
the optical window is positioned between the detection area and the light reception element of the LiDAR device.

8. The abnormality determination device according to claim 6, wherein
the change identification unit is configured to identify the presence or the absence of the change in a light intensity obtained without subtracting the light intensity of the background light image from the light intensity of the reflection light image, as the presence or the absence of the reflection light intensity change,
the brightness identification unit is configured to identify a level of the brightness of the reflection light image obtained without subtracting the light intensity of the background light image and a level of the brightness of the background light image as the level of brightness of each of the reflection light image and the background light image, and
in a case where the change identification unit identifies the absence of both the reflection light intensity change and the background light intensity change, when the brightness identification unit determines that both of the brightness of the reflection light image and the brightness of the background light image are high, and the abnormality determination unit determines that the abnormality type is an abnormality in the light reception element of the LiDAR device or an abnormality due to the presence of a high brightness light source in the detection area.

9. The abnormality determination device according to claim 6, wherein
the change identification unit is configured to identify the presence or the absence of the change in a light intensity obtained without subtracting the light intensity of the background light image from the light intensity of the reflection light image, as the presence or the absence of the reflection light intensity change,
the brightness identification unit is configured to identify a level of the brightness of the reflection light image obtained without subtracting the light intensity of the background light image and a level of the brightness of the background light image as the level of brightness of each of the reflection light image and the background light image, and
in a case where the change identification unit identifies the absence of both the reflection light intensity change and the background light intensity change, when the brightness identification unit determines that the brightness of the reflection light image is low and the brightness of the background light image is high, the abnormality determination unit determines that the abnormality type is an abnormality in the light reception element of the LiDAR device.

10. The abnormality determination device according to claim 6, wherein
in a case where the change identification unit identifies the absence of both the reflection light intensity change and the background light intensity change, when the brightness identification unit determines that both of the brightness of the reflection light image and the brightness of the background light image are high or low, the abnormality determination unit determines that the abnormality type is an abnormality in the light reception element of the LiDAR device.

11. The abnormality determination device according to claim 1, wherein
the image acquisition unit is configured to acquire the reflection light image and the background light image,
the reflection light image represents the intensity distribution of the reflection light obtained by detection of the reflection light, which is the light reflected in the detection area, by the light reception element having sensitivity in a visible region, and
the background light image represents the intensity distribution of the environment light obtained by detection of environmental light that does not include the reflection light in the detection area by the light reception element at a detection timing different from at a detection timing of the reflection light.

12. The abnormality determination device according to claim 1, wherein
the image acquisition unit is configured to acquire the reflection light image and the background light image,
the reflection light image represents the intensity distribution of the reflection light obtained by detection of the reflection light, which is the light reflected in the detection area, by the light reception element of the LiDAR device,
the light reception element of the LiDAR device has sensitivity in a visible region, and
the background light image represents the intensity distribution of the environment light obtained by detection of environmental light that does not include the reflection light in the detection area by a light reception element having sensitivity in a visible region different from the visible region of the light reception element of the LiDAR device.

13. An abnormality determination method executed by at least one processor, the method comprising:
acquiring:
a reflection light image representing intensity distribution of reflection light that is obtained by reflection of light irradiated by a light emitter towards a detection area and detected by a light reception element of a light detection and ranging (LiDAR) device; and
a background light image representing intensity distribution of environment light that is in the detection area, does not include the reflection light, and is detected by the light reception element;
identifying presence or absence of a reflection light intensity change that is a change in a light intensity of the reflection light image for a predetermined time and presence or absence of a background light intensity change that is a change in a light intensity of the background light image for the predetermined time, from the sequentially acquired reflection light image and the sequentially acquired background light image; and
determining an abnormality type of the LiDAR device using a combination of the presence or the absence of the identified reflection light intensity change and the presence or the absence of the identified background light intensity change.

14. A non-transitory computer-readable storage medium storing an abnormality determination program causing at least one processor to:
acquire:
a reflection light image representing intensity distribution of reflection light that is obtained by reflection of light irradiated by a light emitter towards a detection area and detected by a light reception element of a light detection and ranging (LiDAR) device; and
a background light image representing intensity distribution of environment light that is in the detection area, does not include the reflection light, and is detected by the light reception element;
identify presence or absence of a reflection light intensity change that is a change in a light intensity of the reflection light image for a predetermined time and presence or absence of a background light intensity change that is a change in a light intensity of the background light image for the predetermined time, from the sequentially acquired reflection light image and the sequentially acquired background light image; and
determine an abnormality type of the LiDAR device using a combination of the presence or the absence of the identified reflection light intensity change and the presence or the absence of the identified background light intensity change.
